(19) United States
(12) Patent Application Publication
(10) Pub. No.: US 2014/0136210 A1
(43) Pub. Date: May 15, 2014

(54) SYSTEM AND METHOD FOR ROBUST PERSONALIZATION OF SPEECH RECOGNITION

(71) Applicant: AT&T INTELLECTUAL PROPERTY I, L.P., Atlanta, GA (US)

(72) Inventor: Michael J. JOHNSTON, New York, NY (US)

(73) Assignee: AT&T Intellectual Property I, L.P., Atlanta, GA (US)

(21) Appl. No.: 13/676,531

(22) Filed: Nov. 14, 2012

(51) Int. Cl. G10L 15/22

(52) U.S. Cl. CPC G10L 15/22
USPC 704/275

(57) ABSTRACT

Personalization of speech recognition while maintaining privacy of user data is achieved by transmitting data associated with received speech to a speech recognition service and receiving a result from the speech recognition service. The speech recognition service result is generated from a general purpose speech language model. The system generates an input finite state machine from the speech recognition result and composes the input finite state machine with a phone edit finite state machine, to yield a resulting finite state machine. The system composes the resulting finite state machine with a user data finite state machine to yield a second resulting finite state machine, and uses a best path through the second resulting finite state machine to yield a user specific speech recognition result.

### BACKGROUND

1. Technical Field

The present disclosure relates to speech recognition and more specifically to modifying the results of a general purpose language model using user specific data, resulting in a user specific result.

2. Introduction

Performing speech recognition is commonly known to require a language model which utilizes words which can be expected to be spoken by a user. The language models used as part of the speech recognition process can be general purpose language models or can be specific purpose language models.

In one scenario, a system may receive speech from a user and that speech may utilize user specific data such as places, names, activities, and so forth, that are specific to an individual user. However, such information may be private and not desirable to share. In this case, incorporating personalized user specific data into a language model for the purposes of speech recognition can have the effect of violating the user's privacy with respect to their personal information.

### BRIEF DESCRIPTION OF THE DRAWINGS

FIG. 1 illustrates an example system embodiment;

FIG. 2 illustrates an exemplary system for performing robust personalized speech recognition;

FIG. 3 illustrates a first exemplary method embodiment; and

FIG. 4 illustrates a second exemplary method embodiment.

### DETAILED DESCRIPTION

Disclosed herein are systems, methods, computer-readable media and/or a computer-readable device having stored thereon instructions for controlling a processor to perform a method. These systems, methods, media and devices transmit data associated with received speech to a speech recognition service, receive a speech recognition result from the speech recognition service, where the speech recognition result is based on a general purpose language model, and generate an input finite state machine based on the speech recognition results. Systems configured to practice such a method can also include a finite state machine with a phone edit finite state machine, to yield a resulting finite state machine. This resulting finite state machine can be further composed with a user specific finite state machine to yield a second finite state machine. The best path through the second finite state machine can be utilized to provide a user specific speech recognition result.

As can be appreciated, such an approach enables the speech recognition service to be provided separate from a process in which the user specific data can be used to refine the speech recognition results, to provide a user specific speech recognition result. In this regard, the speech recognition service could be separated, and operated, in “the cloud,” and on a client application, which is separate from the speech recognition service, the user specific data can be stored and the processing associated with various finite state machines can occur. In this respect, a robust processing system can maintain private user information of a user application as well as utilize a high-powered speech recognition service in such a way as to preserve the privacy of the user specific data while obtaining the advantages of user specific data in the process of speech recognition.

Various embodiments of the disclosure are described in detail below. While specific implementations are described, it should be understood that this is done for illustration purposes only. Other components and configurations may be used without parting from the scope of the disclosure.

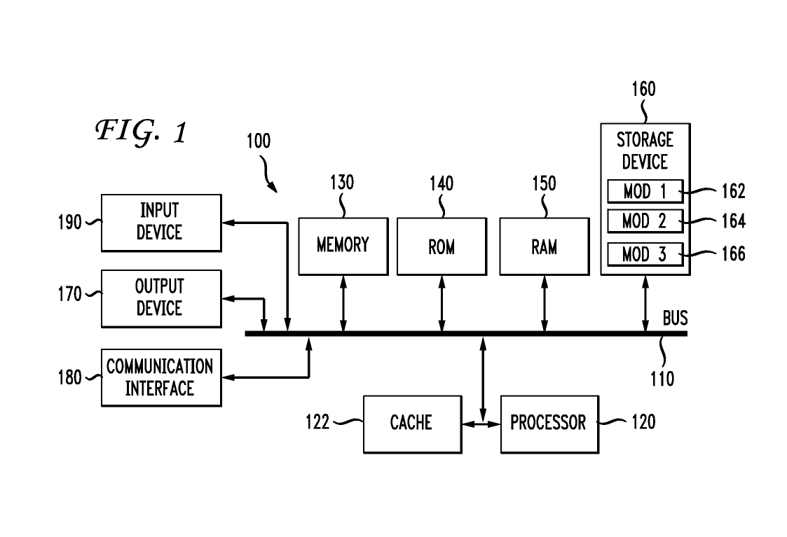

The present disclosure addresses customized speech recognition while maintaining privacy of user specific data. A brief introductory description of a basic general purpose system or computing device in FIG. 1 which can be employed to practice the concepts, methods, and techniques disclosed is illustrated. A more detailed description of means and methods for performing user specific speech recognition while maintaining private user data, described via various configurations and embodiments, will then follow. These variations shall be described herein as the various embodiments are set forth. The disclosure now turns to FIG. 1.

With reference to FIG. 1, an exemplary system or general purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the processor. The processor 120 may be a self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules added or removed based on specific circumstances. The storage device 160 is connected to the system bus 110 by a drive interface. The drives and the associated computer-readable storage media provide nonvolatile storage of computer-readable instructions, data structures, program modules and other data for the computing device 100. In one aspect, a hardware module that performs a particular function includes the software component stored in a tangible computer-readable storage medium in connection with the necessary hardware components, such as the processor 120, bus 110, display 170, and so forth, to carry out the particular function. In another aspect, the system can use a processor and computer-readable storage medium to store instructions which, when executed by the processor, cause the processor to perform a method or other specific actions. The basic components and appropriate variations are selected depending on the type of device, such as whether the device 100 is a small, handheld computing device, a desktop computer, or a computer server.

Although the exemplary embodiments described herein employs the hard disk 160, other types of computer-readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations described below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored in other computer-readable memory locations.

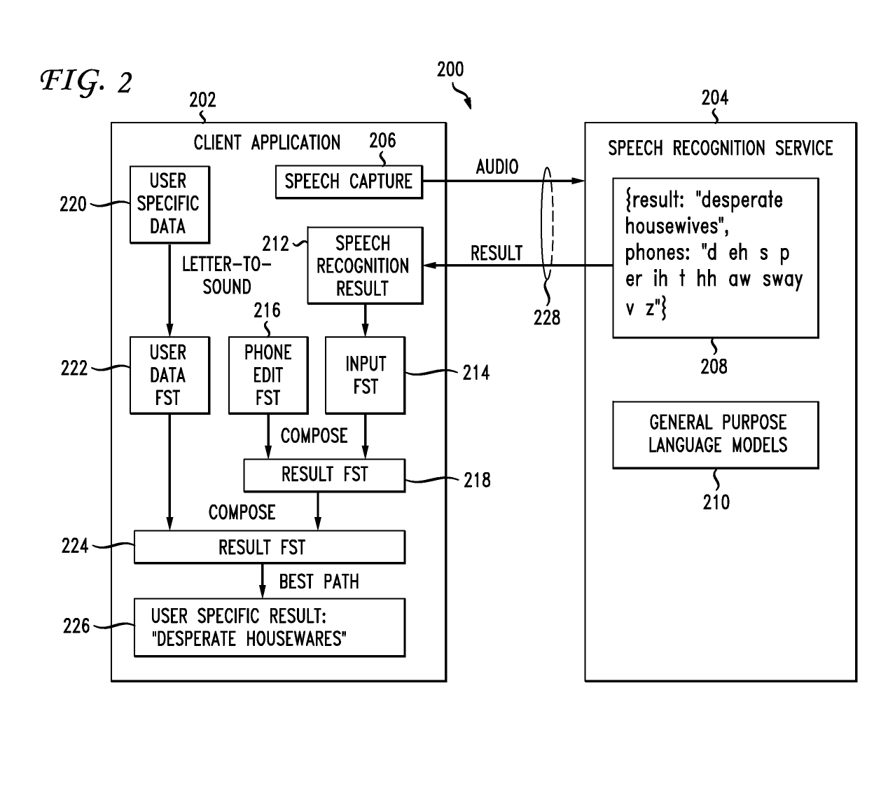

Having disclosed some components of a computing system, the disclosure now turns to FIG. 2, which illustrates a general system for performing robust personalization of speech recognition. As shown in FIG. 2, a system 200 has many components. One is a client application or client device 202. This client application or client device 202 can operate on, or can be, any client device such as a smartphone, desktop computer, hand held device, and so forth. There is no limitation regarding the structure of the client application or client device 202. For purposes of this example, it will be assumed that the client device 202 is a smartphone running the client application that communicates with a speech recognition service 204 which is accessed over a network 228. The network 228 can be any known network such as the Internet, a Local Area Network (LAN), a wireless, Bluetooth, or cellular network, or a combination of various types of networks, for the purpose of communication between the client application 202 and the speech recognition service 204. Generally, the service 204 will have more processing power than client device 202 but this is not critical.

In one aspect, the client application or client device 202 involves speech from a user via a microphone (not shown). A speech capture process 206 receiving the speech and performing some basic processing. There is no restriction on the type of speech capture that can occur. The speech can be encoded or processed for transmission over the network 228. The speech captured is transmitted from the client 202 to the speech recognition service 204, which is assumed in this example to be within “the cloud” or as part of the Internet. The speech recognition service 204 uses a general purpose language model 210 which processes the audio received from the speech capture 206, resulting in a textual version of the audio received. The speech recognition service 204 generates a result, including a proposed speech recognition result 208 as well as other possible data. The result 208 includes text representing the speech of the user. For example, the result 208 can include other data such as particular phonemes that are part of the result of the speech recognition processing. The general purpose, rather than user specific, language models 210 can recognize multiple categories of audible speech, such as contacts, location names, and favorite items such as television shows, song names, or podcasts. However, these models 210 do not contain user specific lexical items, and do not weight the recognized speech for a particular user. Therefore, the result 208 produced is not customized to any particular user.

Moreover, the result 208, in addition to the words corresponding to the received speech interpreted by the general purpose language model 210, the system 204 can return some phoneme segmentation of the utterance, which can also include tagged subparts of the utterance. For example, if the system 204 recognizes the utterance “Find show Desperate Housewives,” the service 204 can return the string, the phoneme sequence, and an abstract version of the string with tags, a list of attributes from the abstracted version, along with the corresponding phoneme sequences. In some aspects, in addition to a top scoring string, the speech recognition service 204 result can be an n-best list of phone and word sequences, or a lattice representation of words and/or phones. The client device 202 will then use the result 208 and any other data provided with the result to customize the result 208 to the specific user. The “other” data can include any data available to the service 204 that can be helpful to the client device 202 in processing the speech recognition results. For example, social networking data, news, information about birthdays or events, etc. could be included as part of the other data.

Next, the result is received at the client device 202 as a speech recognition result 212. What follows is a series of steps which are taken to determine which of a user specific set of items is the closest match to the speech recognition result 212. A letter-to-sound algorithm and optionally a pronunciation dictionary are used to build a finite state transducer whose input enumerates the phoneme sequences of the user items and the output enumerates the corresponding words.

Underlining the use of finite state transducers is the concept of a finite state automaton. A finite state automaton is known and understood by those of skill in the art. Typically, a finite state automaton receives a word or a string of letters and perform a particular process. The finite state automaton recognizes the set of strings in the same way that a regular expression does. An automaton is represented as a directed graph or finite state vertices or nodes together with a set of directed links between the pairs of vertices which are called arcs. Arcs are often illustrated with arrows between one node and another. The initial state of an automaton is a start state which is represented by an incoming arrow. Between each of the states is an arc with a value which can be associated with a letter in a string. The last state is a final state or an accepting state which is usually represented by a double circle. The finite state automaton begins with the start state and iterates a process where if the first letter in the input matches the symbol on an arc leaving the start state, then the machine crosses that arc and moves on to the next state. This process continues advancing one symbol per node until the accepting state is arrived at or the system runs out of input. The system can then successfully recognize an instance of a word or a text input. If the system never gets to the final state or runs out of input, the machine or the finite automaton will reject or fail the acceptance of the input. As an example, a finite state automaton could have four nodes and be arranged to process the word “cat.” The transition from the first node to the second node would be for the “c,” and from the second node to the third node the transition arc would be “a,” and between the third node and the fourth node the arc would be “t.” If the automaton arrived at the forth acceptor node, it would return “accept.”

A finite state transducer is a mapping between two different levels of an item. For example, a finite state transducer can map between a surface level of a word, which can represent its actual spelling, and a lexical level, which can represent a simple concatenation of morphemes that make up a word. The transducer therefore maps between one set of symbols and another and a finite state transducer does this via a finite state automaton. The finite state transducer defines a relation between a set of strings and it can be a machine that reads one string and generates another. There are several aspects of finite state transducers that can be relevant to their interpretation. In one aspect, a finite state transducer can act as a recognizer that takes a pair of strings as input and output an “accept” if the string-pair is in the string-pair language, and can output a “reject” if it is not. In another aspect, a finite state transducer can act as a generator that outputs pairs of strings of the language. Thus, the output is a yes or no and a pair of output strings. In another aspect, the finite state transducer can act as a translator that reads a string and outputs another string. Finally, the finite state transducer can act as a set relater that computes relations between sets of input. Any of these aspects can apply to the present disclosure.

It is understood that one of skill in the art would understand these concepts as well as other concepts such as composing transducers together. Composing is a way of taking a cascade of transducers with many different levels of inputs and outputs and converting them into a single two-level transducer with one input tape and one output tape. Composing can involve taking two transducers with a set of states and transition functions and creating a new possible state (x,y) for every pair of states contained within the first transducer and the second transducer. This yields a new automaton having a new transition function. In certain instances, composing two finite state transducers can comprise assigning a cost to an operation that results in a manipulation of an input sequence and/or substitution of phonemes.

The disclosure now turns back to the specific discussion of the concepts disclosed herein. The result 212 of the speech recognition service 204 is a text corresponding to the audio captured, e.g. a show title in the case of “Find show Desperate Housewives,” as well as a phoneme sequence for the relevant item. The system or client device 202 encodes this result as an input finite state transducer 214. This input finite state transducer 214 is then composed with a phone edit finite state transducer 216. The phone edit finite state transducer 216 performs a number of functions, including assigning costs to various operations that manipulate the input sequence by at least one of insertion, deletion, and substitution of phonemes. The resulting finite state transducer (A◯B) 218 is then further composed with a user specific data finite state transducer 222. The user specific finite state transducer 222 is generated using a letter-to-sound algorithm and/or dictionaries using user specific data 220. Thus, the resulting finite state transducer (A) 218 is composed with the user data finite state transducer 222, to yield a second result finite state transducer (B) 224 C((A◯B)◯C). The lowest cost path or path(s) in ((A◯B)◯C) are selected and the closest matching strings to a user-specific result are the output of the resulting finite state transducer (B) 224. In this case, the general purpose recognizer returned the result “Desperate Housewives,” which was then composed with the phone edit finite state transducer 216, then further composed with the user data finite state transducer 222. By composing the user data finite state transducer 222 with the input and phone edit finite state tranducers 214, 216, a user specific result of “Desperate Housewares” 226 was determined, as is shown in FIG. 2.

It is noted that one particular embodiment is described where phoneme to phoneme editing is employed. Other matching techniques can also be substituted or added which compare matches on the word or sub-word level, or use the orthography directly. Several improvements are provided via the embodiments described herein. Specifically, separating user data from the general purpose speech processor removes the requirement to upload user data to a speech service. Furthermore, these embodiments alleviate the need to record and maintain models/profiles for individual users at the speech recognition service 204. The approach also enables the use of a single model for multiple different customers and tasks.

In one aspect, the user specific data 220 stored on the client application 202 continually changes. For example, the system may periodically generate and/or update the user specific data 220 and the user data finite state transducer 222. The update can occur at fixed periodic intervals or can occur on a trigger basis, where the user or circumstances initiate updating of the data/transducer. As an example of a trigger basis, when user specific data 220 such as contacts, calendaring information, email, texts, or any other data associated with the user specific data are updated, that update can serve as the basis for triggering changes to the user specific transducer 222.

In addition, the client application 202 can have an interface which allows the user to type in or add user specific data. For example, if the user knows that they are going to be on a particular trip with specific sights, shows, movies, and location, the user could take an itinerary and upload or otherwise provide the itinerary to the client application 202, which can incorporate the itinerary into the user specific data 220. The system can then update the user data finite state transducer 222 based on the updated user specific data 220. Thereafter, as the speech capture 206 and the speech recognition service 204 process occurs for speech following the update, the benefit of the itinerary data can be incorporated into the speech processing performed by the client application 202, and thus improve the ability of the system to provide a user specific result 226 based on such data.

As an example, consider an individual travelling to Fargo, N. Dak. The user interacts with a user interface, informing the client device 202 of the itinerary. The interaction updates user specific data 220 and a user data finite state transducer 222 with relevant words such as “Fargo” and “North Dakota”. The user then, during their travels, provides audio which the client device 202 captures 206. A general purpose language model 210 is used by a speech recognition service 204 to produce a generic result, and possibly phoneme data or other data. This result 208 is then transmitted back to the client device 202, and the received result 212 is transformed into an input finite state transducer 214. The input finite state transducer 214 is composed with a phone edit finite state transducer 216, and the resulting finite state transducer 218 is then further composed with the user data finite state transducer 222 (which contains the information specific to Fargo, N. Dak.). By composing the result 218 with the user specific data 222, a result can be determined which is the best probable match for the user, based on the user's personal data, the phone edit information, and the generic language model interpretation. The final user-specific result is then output to the user.

Other benefits of this solution also include recognition of user specific items, where the user specific items are not disclosed or otherwise shared with the speech recognition service 204. This clearly maintains the user/customer privacy and alleviates the need to maintain a database of models and/or profiles of all users and customers in the cloud or as part of the speech recognition service. This updating is also easier in the case of smartphones, as the update of user specific data can often occur as the users are interacting with other people and systems via their smartphones, and updating contacts, locations, and preferences during that interaction. This approach clearly does not imply that speech language models need to be customized or otherwise modified for a specific user. Instead, a general language model 210 is used for initial recognition of the utterance. At a second stage, a finite stage transducer 224 based on user specific data 220 is applied to the speech recognition result 212 of the general purpose language model 210, resulting in a user specific result 226. Application of the finite state transducer 224 allows the system to find a best match among various possibilities by analyzing various paths through the resulting finite state transducer 224, with the best match being determined for a specific user profile.

An additional benefit is provided in terms of scale, such that a cloud based speech recognition service can be scaled in such a manner that the general purpose language model 210 does not need to be updated on an individual basis for each user of the speech recognition service 204.

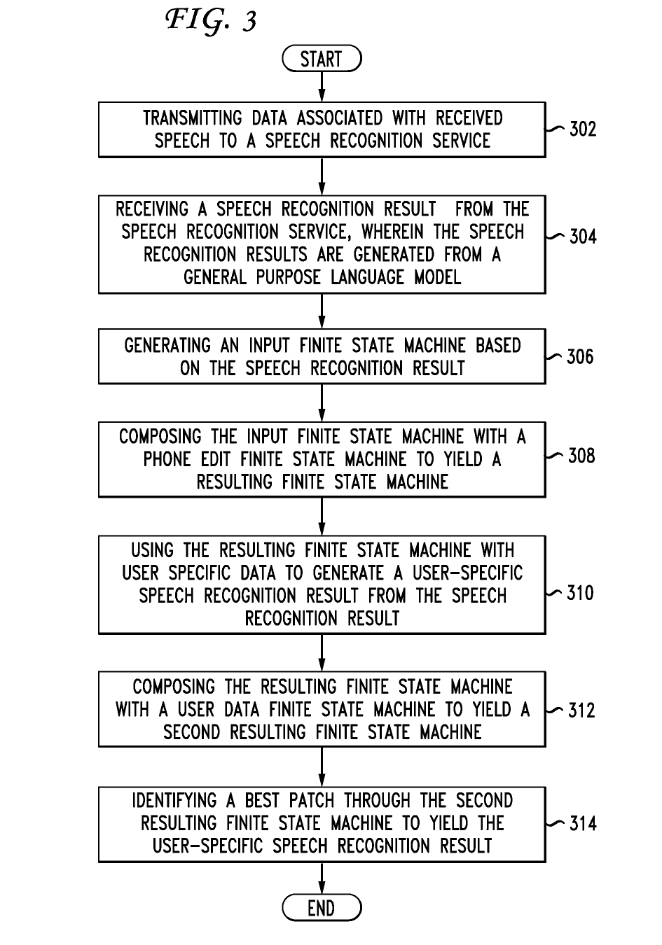

Having disclosed some basic system components and concepts, the disclosure now turns to the first exemplary method embodiment shown in FIG. 3. For the sake of clarity, the method is described in terms of an exemplary system 100 as shown in FIG. 1 configured to practice the method. The steps outlined herein are exemplary and can be implemented in any combination thereof, including combinations that exclude, add, or modify certain steps.

FIG. 3 illustrates a first example method embodiment performed as instructed by instructions stored on a computer-readable storage medium or computer-readable device and executed by a processor or on the computer-readable device. This method includes transmitting data associated with received speech to a speech recognition service (302), receiving a speech recognition result from the speech recognition service, wherein the speech recognition result is generated from a general purpose language model (304), and generating an input finite state machine based on the speech recognition result (306). The method also includes composing the input finite state machine with a phone edit finite state machine to yield a resulting finite state machine (308) and using the resulting finite state machine with user specific data to generate a user-specific speech recognition result from the speech recognition result (310).

The following is an example of the use of a phone edit finite state machine. Assuming the recognition result is “desperate housewives.” One example of the phoneme sequence for this phrase is: d eh s p er ih t hh aw s w ay v z. Other sequences could be used as well. The phoneme sequence can be represented as a lattice or a phoneme result finite state machine in which each phoneme labels an arc. When the system composes the phoneme label finite state machine a phone edit transducer it adds in throughout the possibility at each node in the finite state machine, one of deleting, inserting or substituting each phoneme, all at some cost. For example, for deletion, the first two nodes, labelled ‘d’, the system would add a new arc with some cost where the symbol is an epsilon. The system would also add in arcs for changing ‘d’ to a different phoneme, and on the nodes there would be arcs that allow insertion of other phonemes. The composing process would result in a much larger finite state machine, but traveling through the lowest cost path would still result in: d eh s p er ih t hh aw s w ay v z.

When composing the input finite state machine with the phone edit finite state machine, the method can further include assigning a cost to an operation which results in the manipulation of the input sequence of the input finite state machine to insert data. Other results could include deleting data from the input finite state machine, or substituting data in the input finite state machine. This process can utilize the data that is returned as part of the speech recognition result. For example, the phoneme segmentation, the tagged portions of the utterance, and so forth can be utilized as part of the operation of the phone edit finite state machine to adjust the data by insertion, deletion, and/or substitution in order to prepare the finite state machine for further processing.

In another aspect, the method includes composing the finite state machine with a user data finite state machine to yield a second resulting finite state machine (312). In yet another aspect, using the second resulting finite state machine with user specific data further includes producing a best match, or a best path, through the second resulting finite state machine, to yield the user specific speech recognition result (314).

An example follows of using the user data finite statement machine. The system combines the finite state machine with another which, on the input side, has the phoneme sequences of a person's specific information and on the output side has the words of the specific information. As a result of the composition, the system picks out a path which is a) found in the input side of the user specific data finite state transducer and b) the lowest cost path through the edit machine.

If the recognized string is also in the person's contacts then the system uses that term and, if not, the system will ‘edit’ to the closest matching string that is in the user's specific information. So in the example above, where the specific data is the showname: desperate housewares, the system will end up finding a path where ay --> ey and v-->r: d eh s p er ih t hh aw s w ey r z, unless there is some other name in the user's specific list of shows, that is even closer to the recognized string.

In this manner, this method enables a system such as shown in FIG. 2 to provide robust personalized speech recognition in a scalable manner and in a manner that preserves the privacy of user specific data. Furthermore, it provides a simple and easily upgradeable system, which in turn enables user specific data to be updated in near real-time as the client application receives updated data.

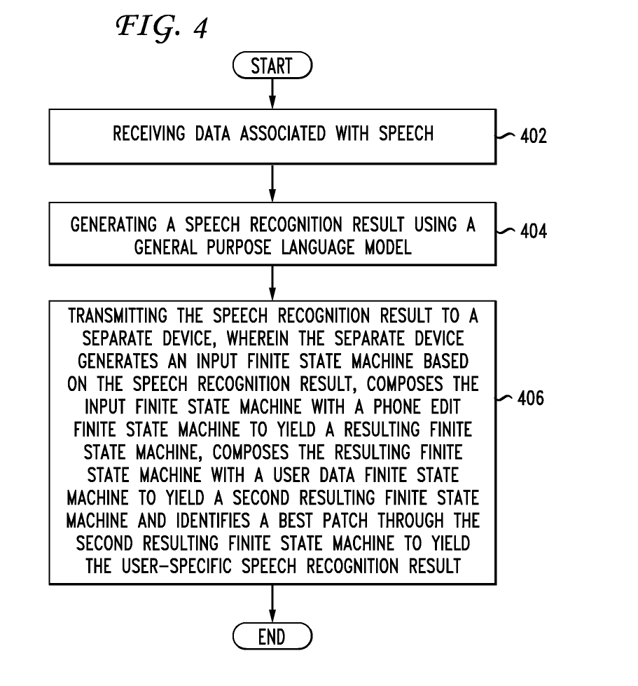

FIG. 4 illustrates a second exemplary method of the system 100 illustrated in FIG. 2, from the standpoint of the speech recognition service 204. In this respect, the processing is performed by the speech recognition service. In this case, the system receives data associated with the speech (402) and generates a speech recognition result using a general purpose language model (404). The system 100 can then transmit the result with optional data, including phoneme segmentation, tags, and other data to a separate device (406) which receives the speech recognition results and generates an input finite state machine based on the speech recognition results. The system 100 then composes the input finite state machine with a phone edit finite state machine to yield a resulting finite state machine, and composes the resulting finite state machine with a user data finite state machine to yield a second resulting finite state machine. Finally, the system 100 identifies a best path through the second resulting finite state machine, to yield the user-specific speech recognition results. As can be appreciated, this approach maintains the privacy of user specific data.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can apply to any personalization of speech recognition results. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

We claim:

1. A method comprising:
transmitting data associated with received speech to a speech recognition service;
receiving a speech recognition result from the speech recognition service, wherein the speech recognition result is generated from a general purpose language model;
generating an input finite state machine based on the speech recognition result;
composing the input finite state machine with a phone edit finite state machine to yield a resulting finite state machine; and
using the resulting finite state machine with user specific data to generate a user-specific speech recognition result from the speech recognition result.

2. The method of claim 1, wherein composing the input finite state machine with a phone edit finite state machine further comprises assigning a cost to an operation that results in a manipulation of an input sequence in the input finite state machine to insert data.

3. The method of claim 1, wherein composing the input finite state machine with a phone edit finite state machine further comprises assigning a cost to an operation that results in a manipulation of an input sequence in the input finite state machine to delete data.

4. The method of claim 1, wherein composing the input finite state machine with a phone edit finite state machine further comprises assigning a cost to an operation that results in a manipulation of an input sequence in the input finite state machine to substitute phoneme data.

5. The method of claim 1, further comprising:
composing the resulting finite state machine with a user data finite state machine to yield a second resulting finite state machine.

6. The method of claim 5, wherein using the resulting finite state machine with user specific data comprises identifying a best path through the second resulting finite state machine to yield the user-specific speech recognition result.

7. The method of claim 1, wherein using the resulting finite state machine to generate a user specific speech recognition result is performed on a smartphone.

8. A computer-readable medium having instructions stored which, when executed by a processor, perform a method comprising:
transmitting data associated with received speech to a speech recognition service;
receiving a speech recognition result from the speech recognition service, wherein the speech recognition result is generated from a general purpose language model;
generating an input finite state machine based on the speech recognition result;
composing the input finite state machine with a phone edit finite state machine to yield a resulting finite state machine; and
using the resulting finite state machine with user specific data to generate a user-specific speech recognition result from the speech recognition result.

9. The computer-readable medium of claim 8, wherein composing the input finite state machine with a phone edit finite state machine further comprises assigning a cost to an operation that results in a manipulation of an input sequence in the input finite state machine to insert data.

10. The computer-readable medium of claim 8, wherein composing the input finite state machine with a phone edit finite state machine further comprises assigning a cost to an operation that results in a manipulation of an input sequence in the input finite state machine to delete data.

11. The computer-readable medium of claim 8, wherein composing the input finite state machine with a phone edit finite state machine further comprises assigning a cost to an operation that results in a manipulation of an input sequence in the input finite state machine to substitute phoneme data.

12. The computer-readable medium of claim 8, the computer-readable medium having additional instructions stored which result in the method further comprising:
composing the resulting finite state machine with a user data finite state machine to yield a second resulting finite state machine.

13. The computer-readable medium of claim 12, wherein using the resulting finite state machine with user specific data comprises identifying a best path through the second resulting finite state machine to yield the user-specific speech recognition result.

14. The computer-readable medium of claim 8, wherein the processor is a part of a smartphone.

15. A system comprising:
a processor; and
a computer-readable medium having instructions stored which, when executed by the processor, perform a method comprising:
transmitting data associated with received speech to a speech recognition service;
receiving a speech recognition result from the speech recognition service, wherein the speech recognition result is generated from a general purpose language model;
generating an input finite state machine based on the speech recognition result;
composing the input finite state machine with a phone edit finite state machine to yield a resulting finite state machine; and
using the resulting finite state machine with user specific data to generate a user-specific speech recognition result from the speech recognition result.

16. The system of claim 15, wherein composing the input finite state machine with a phone edit finite state machine further comprises assigning a cost to an operation that results in a manipulation of an input sequence in the input finite state machine to insert data.

17. The system of claim 15, wherein composing the input finite state machine with a phone edit finite state machine further comprises assigning a cost to an operation that results in a manipulation of an input sequence in the input finite state machine to delete data.

18. The system of claim 15, wherein composing the input finite state machine with a phone edit finite state machine further comprises assigning a cost to an operation that results in a manipulation of an input sequence in the input finite state machine to substitute phoneme data.

19. The system of claim 15, the computer-readable medium having additional instructions stored which result in the method further comprising:
composing the resulting finite state machine with a user data finite state machine to yield a second resulting finite state machine.

20. The system of claim 19, wherein using the resulting finite state machine with user specific data comprises identifying a best path through the second resulting finite state to yield the user-specific speech recognition result.
